(19) United States
(12) Patent Application Publication
(10) Pub. No.: US 2008/0035400 A1
(43) Pub. Date: Feb. 14, 2008

(54) Airflow diverter

(75) Inventors: Alec Wong, Bellevue, WA (US); John Duffy, Seattle, WA (US); Harold M. Whitaker, Redmond, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: PACCAR Inc, Bellevue, WA (US)

(21) Appl. No.: 11/501,308

(22) Filed: Aug. 8, 2006

(51) Int. Cl. B60K 11/00

(52) U.S. Cl. 180/68.1

(57) ABSTRACT

In a vehicle (10) of the type having an engine (12) and a radiator (14), an airflow diverter (20) is attachable in fluid receiving communication with the radiator. The airflow diverter generally includes a formed foil (22) having an arcuate portion (24), the formed foil, when placed in an airstream (16), is capable of redirecting the airstream from a first direction (32) to at least a second direction (34).

### TECHNICAL FIELD

Embodiments of the present disclosure relate generally to airflow diverters, and more specifically, to airflow diverters attachable in fluid receiving communication with radiators.

### BACKGROUND

In previously developed engine cooling systems for vehicles, ambient air is directed toward an engine as it is pulled through a radiator by a fan and a fan shroud. As seen in FIG. 1, upon exiting the radiator fan shroud 14, the airstream 16 travels downward, where it contacts the ground and bounces back into or near the engine compartment 12. A portion of this airstream 16 that hits the ground can be directed toward the front end of the vehicle 10 and recirculated into the ambient air entering the radiator 14. Recirculating the heated airstream back through the radiator can decrease the cooling capacity of the radiator. The recirculated airstream also may carry dirt and debris from the ground into the radiator, resulting in damage to the radiator.

A previously developed solution to this problem is the placement of a substantially linear airflow “ejector” underneath the radiator, for example, as seen in U.S. Pat. Nos. 5,626,185 and 5,526,872, both issued to Gielda et al. The previously developed airflow ejectors theoretically redirect discharged air to a new path, such that the discharged air flows underneath the vehicle so that the air does not bounce back into the engine compartment. However, the redirected discharged air form these substantially linear (i.e., non-arcuate) ejectors tends to “eject” in a non-uniform manner, resulting in non-linear redirected airflow. Thus, there exists a need for an improved airflow diversion.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, an airflow diverter is provided. In a vehicle of the type having an engine and a radiator, the airflow diverter is attachable in fluid receiving communication with the radiator. The airflow diverter includes a formed foil having a downwardly and rearwardly extending arcuate portion. The formed foil, when placed in an airstream, is capable of redirecting the airstream from a first direction to at least a second direction.

In accordance with another embodiment of the present disclosure, an airflow diverter is provided. In a vehicle of the type having an engine and a radiator, the airflow diverter is attachable in fluid receiving communication with the radiator. The airflow diverter includes a formed foil having first and second chutes, each chute having a downwardly and rearwardly extending arcuate portion. The first chute, when placed in an airstream, is capable of redirecting the airstream from a first direction to at least a second direction. Thee second chute, when placed in an airstream, is capable of redirecting the airstream from a first direction to at least a third direction.

### DESCRIPTION OF THE DRAWINGS

The foregoing aspects and many of the attendant advantages of this disclosure will become more readily appreciated by reference to the following detailed description, when taken in conjunction with the accompanying drawings, wherein:

FIG. 1 is a side view of a vehicle engine and engine cooling system without an airflow diverter;

FIG. 2 is a side view of a vehicle engine and engine cooling system having an airflow diverter formed according to various aspects of the present disclosure;

FIG. 3 is a bottom view of the vehicle engine and engine cooling system having an airflow diverter in accordance with one embodiment of the present disclosure;

FIG. 4 is a perspective view of the airflow diverter of FIG. 3;

FIG. 5 is a front view of the airflow diverter of FIG. 3;

FIG. 6 is a side view of the airflow diverter of FIG. 3;

FIG. 7 is a bottom view of the vehicle engine and engine cooling system having an airflow diverter in accordance with another embodiment of the present disclosure;

FIG. 8 is a perspective view of the airflow diverter of FIG. 7;

FIG. 9 is a front view of the airflow diverter of FIG. 7; and

FIG. 10 is a side view of the airflow diverter of FIG. 7.

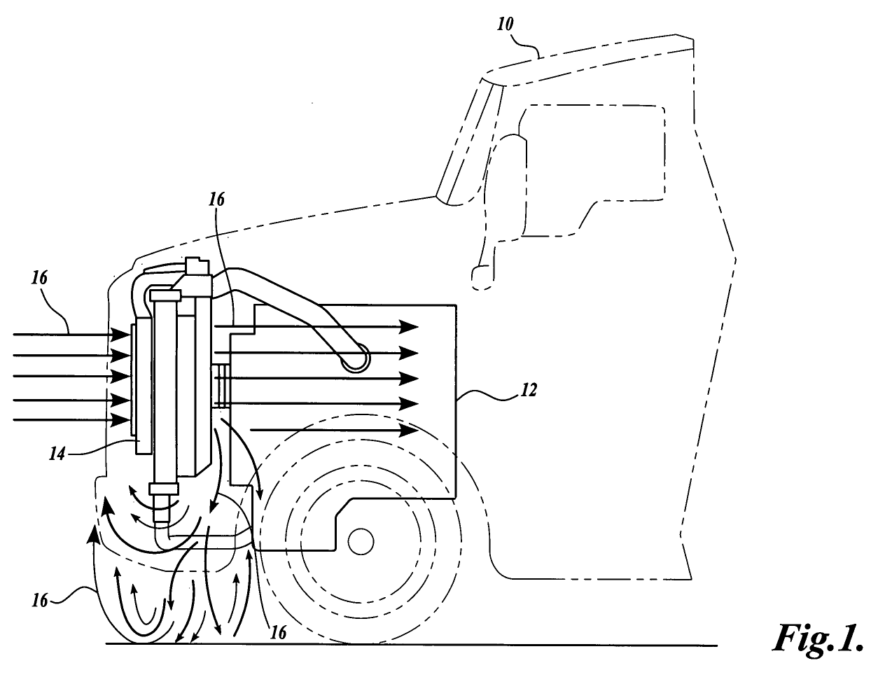

### DETAILED DESCRIPTION

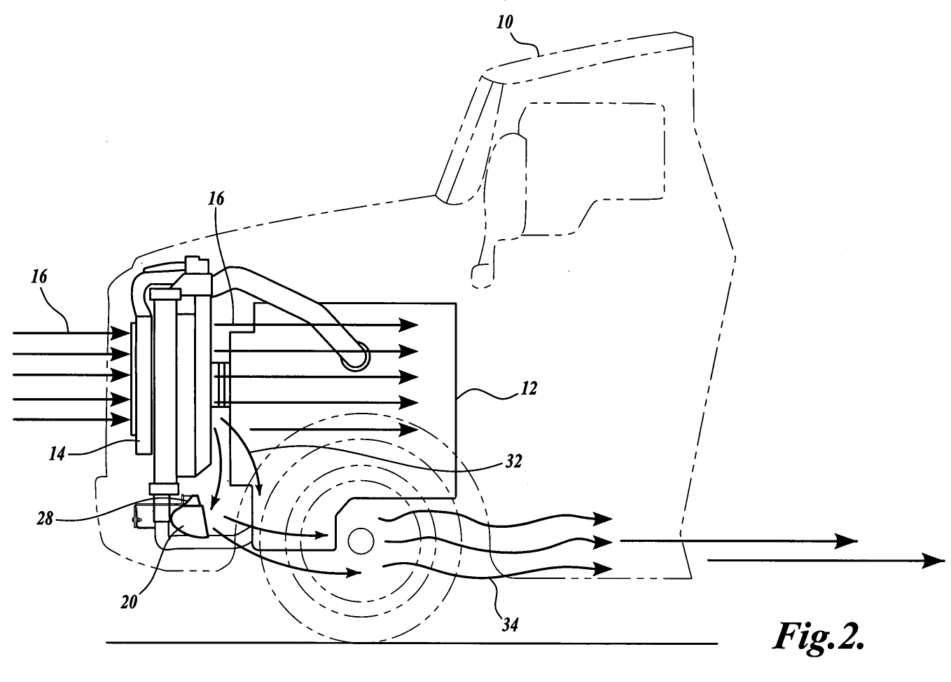

Embodiments of the present disclosure are generally directed to airflow diverters for substantially reducing air recirculation into engine cooling systems. Referring to FIG. 2, in a vehicle 10 of the type having an engine 12 and a radiator 14, an airflow diverter 20 is attachable in fluid receiving communication with the radiator 14. The airflow diverter 20 includes a formed foil 22 having a downwardly and rearwardly extending arcuate portion 24 (see FIG. 6). When the formed foil 22 is placed in an airstream 16 discharged from the radiator outlet, the formed foil 22 is capable of redirecting the airstream 16 from a first direction 32 to at least a second direction 34.

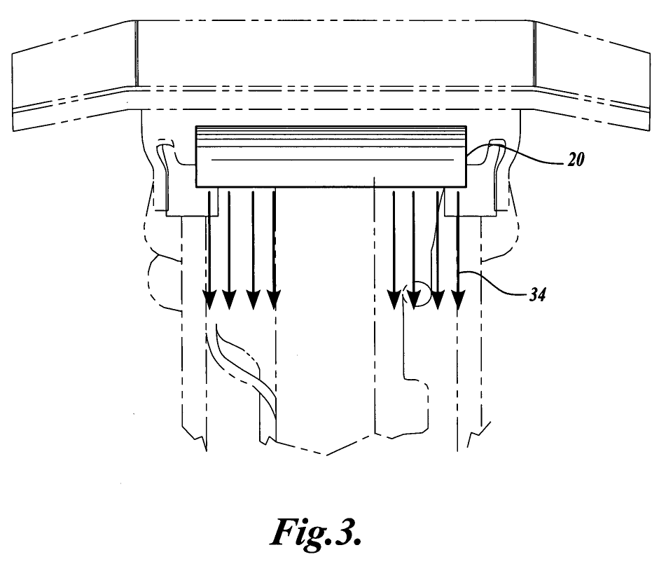

As seen in FIGS. 2 and 3, the airflow diverter 20 redirects airflow 16 discharged from the radiator 14 from a first direction 32 (e.g., a substantially downward or vertical path) to a second direction 34 (e.g., a substantially rearward or horizontal path), such that radiator discharge flows substantially parallel to the ground underneath the vehicle 10 and does not bounce back off the ground either toward the engine 12 or for recirculation back into the radiator 14. The second direction 34 may be substantially lateral, when compared to the first direction 32.

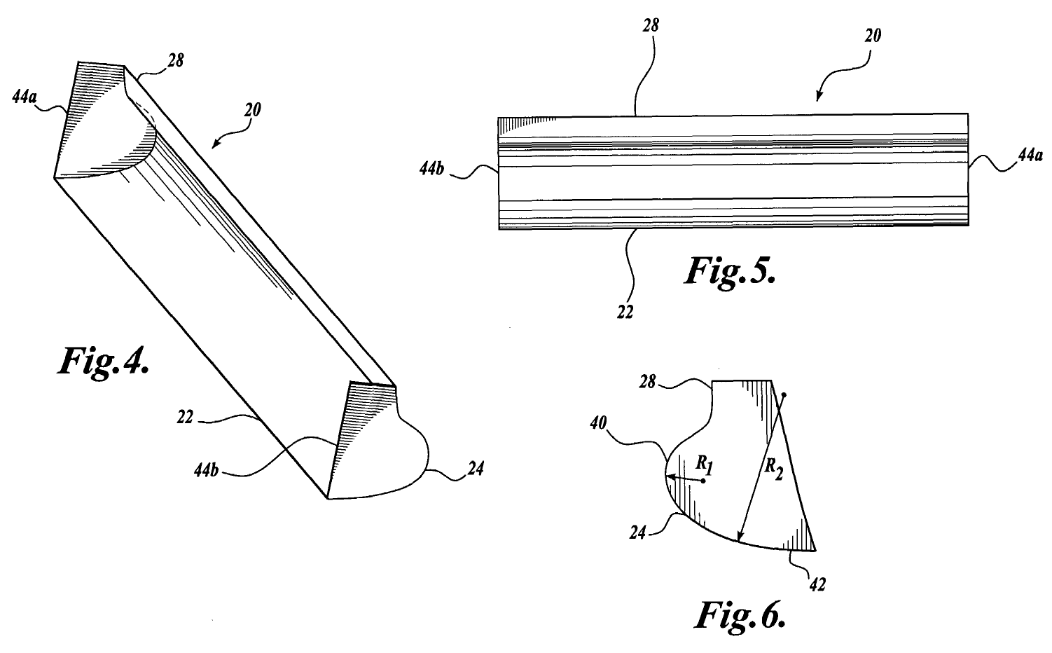

The airflow diverter 20 formed foil 22 will now be described in greater detail. As best seen in the illustrated embodiment of FIGS. 4-6, the formed foil 22 includes an elongate vehicle attachment portion 28 coupled to an elongate arcuate portion 24. The vehicle attachment portion 28 is a substantially linear lip capable of attachment to the vehicle 10 under the hood, for example, by bracket attachment underneath the radiator 14, as seen in FIG. 2.

The arcuate portion 24 has at least a first upper radius of curvature R1 and a second lower radius of curvature R2. The first radius of curvature R1 is less than the second radius of curvature R2. Due to the differing radii of curvature, the first radius of curvature R1 forms a partial “C”-shaped chamber 40, and the second radius of curvature R2 forms a substantially curvilinear exit foil 42 from the partial “C”-shaped chamber 40. The vehicle attachment portion 28 is coupled to the arcuate portion 24 at a first upper end of the partial “C”-shaped chamber 40. The airflow diverter 20 is designed and configured such that airflow enters the airflow diverter 20 at the first upper end of the partial “C”-shaped chamber 40 and exits the airflow diverter 20 at the substantially curvilinear exit foil 42.

As will be described in greater detail below, such an arcuate portion 24 having first and second radii of curvature R1 and R2 redirects the first direction 32 of an airstream 16 from the radiator 14 to a second direction 34. As seen in FIGS. 2 and 3, the first direction 32 is substantially downward and the second direction 34 is substantially rearward, away from the radiator 14 and the engine 12 of the vehicle 10.

In one embodiment, the formed foil 22 is in the shape of a scoop. In that regard, the formed foil 22 includes first and second sidewalls 44a and 44b at the respective ends of the arcuate portion 24. It should be appreciated, however, that the first and second sidewalls 44a and 44b may be oriented substantially perpendicular to the arcuate portion 24 (e.g., as seen in FIGS. 3-6) or oriented at another angle besides 90 degrees relative to the arcuate portion 24, for example, to flare outwardly (not shown). Referring to FIG. 3, a bottom perspective view of the airflow diverter 20 with perpendicular sidewalls 44a and 44b is seen, which depicts a discharged airstream from the radiator 14 redirected in a second direction 34 (i.e., substantially rearwardly and substantially parallel to the ground) underneath the engine 12 of the vehicle 10. In an embodiment having flaring sidewalls (not shown), a discharged airstream from the radiator 14 is redirected substantially parallel to the ground and outwardly (i.e., to the left and right sides of the vehicle 10) away from the engine 12 of the vehicle 10.

The operation of the airflow diverter 20, when in fluid receiving communication with the radiator 14, will now be described with reference to FIGS. 2 and 3. When the vehicle is in motion and/or during use of the radiator, an airstream 16 is drawn through the radiator 14 to cool the engine 12. Some of the exiting airstream 16 hits the engine block 12 and flows downward from the radiator 12 in a first direction, as depicted by arrows 32 in FIG. 2.

As the airstream 16 passes over the airflow diverter 20, a pressure differential is created between the airstream flowing in the first, substantially downward direction 32 and the airstream in the partial “C”-shaped chamber 40 of the arcuate portion 24 of the airflow diverter 20 formed foil 22, such that the partial “C”-shaped chamber 40 becomes a low pressure fluid pocket. Thus, the lower pressure of the partial “C”-shaped chamber 40 creates at least a partial vacuum, which draws the airstream flowing in the first direction 32 into the partial “C”-shaped chamber 40 and induces fluid turbulence in the partial “C”-shaped portion. The turbulent airflow in the arcuate portion 24 travels along the partial “C”-shaped portion to the substantially curvilinear exit foil 42. Thus, the airflow exits the airflow diverter 20 in a second, substantially rearward direction 34, as a turbulent, but substantially linear airflow.

Such discharged airstream 16 redirection promotes underbody airflow distribution substantially parallel to the ground. With underbody airflow substantially parallel to the ground, there is less likelihood that discharged air will hit the ground and bounce up, kicking up dirt and debris from the ground. Such improved underbody airflow distribution reduces cooling component fouling and improves overall vehicle cooling system efficiency.

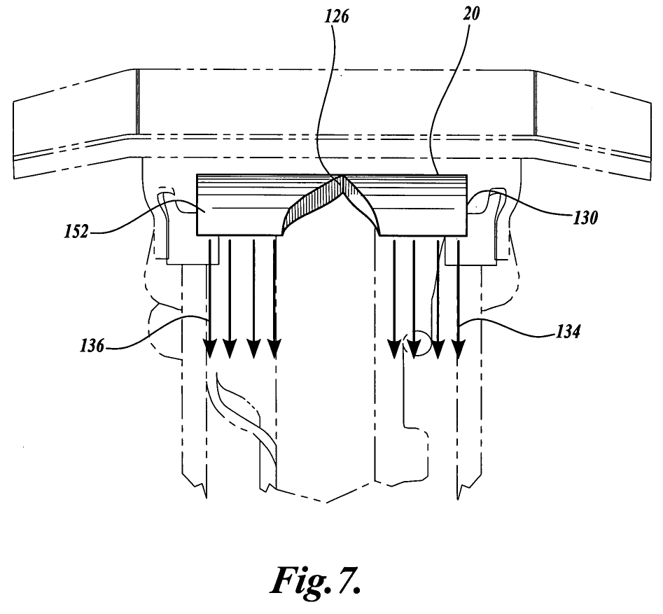

Now referring to FIGS. 7-10, airflow diverters having formed foils of other shapes will now be described in greater detail. The diverters are similar in materials and operation as the previously described embodiment, except for a difference regarding a plurality of chambers and the shape of such chambers within the formed foil, which will be described in detail below. For clarity in the ensuing descriptions, numeral references of like elements of the airflow diverter 20 are similar, but are in the 100 series for the illustrated embodiment of FIGS. 7-10.

As seen in FIGS. 7-10, formed foil 122 of the airflow diverter 120 includes a splitting device 126, which divides the formed foil 122 into first and second airflow diverter chutes 150 and 152. In the illustrated embodiment of FIGS. 7-10, the splitting device 126 is a wedge-shaped splitter between the first and second chutes 150 and 152. In the illustrated embodiment, the splitting device 126 is designed and configured such that the chutes 150 and 152 are asymmetrical. However, it should be appreciated that symmetrical chutes are also within the scope of the present disclosure. It should further be appreciated that a plurality of splitting devices 126 resulting in more than two chutes 150 and 152 are within the scope of the present disclosure.

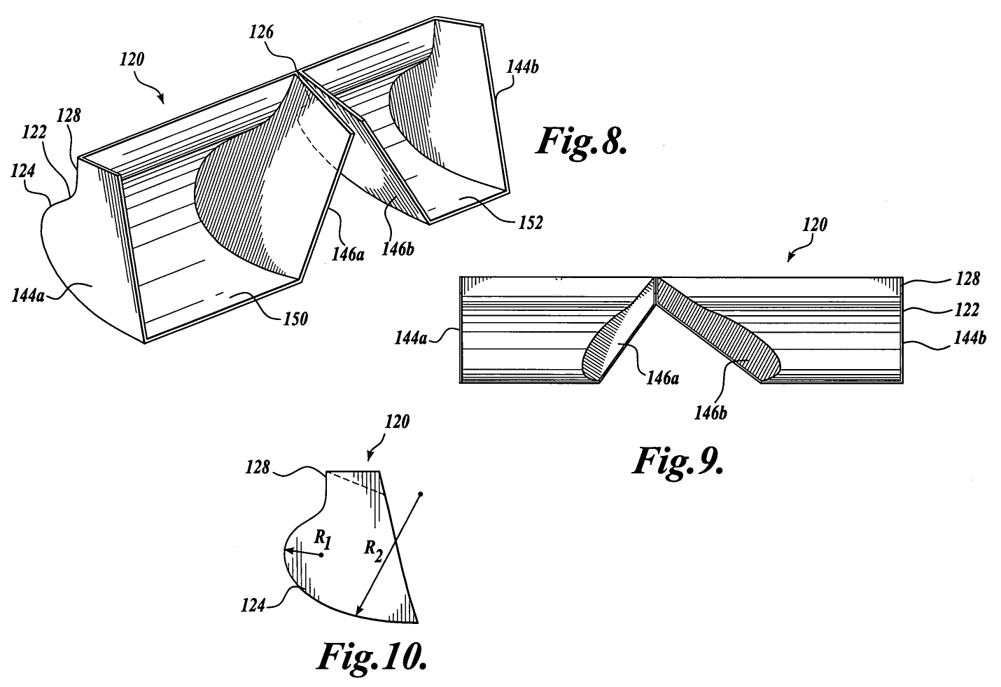

In use, the first and second chutes 150 and 152 divide discharged airflow from the diverter 120 into left and right paths to redirect the discharged airstream 16 in a substantially rearward and horizontal, but divided, path underneath the vehicle 10. In that regard, each chute 150 and 152 of the present embodiment of the airflow diverter 120 resides between two sidewalls 144a and 146a and 144b and 146b. Each chute 150 and 152 is also defined by a downwardly and rearwardly extending arcuate portion 124 having at least a first upper radius of curvature R1 and a second lower radius of curvature R2. With reference to FIGS. 8-10, the inner sidewalls 146a and 146b are adjacent one another along their upper ends, tapering outwardly from the portion of the formed foil 122 where the airstream 16 enters to the portion of the formed foil 122 where the airstream 16 exits. Due to this tapering, the inlet airstream 16 enters the formed foil 122 in a first direction 132 (similar to airflow 32 in FIG. 2), and as it enters, is divided into the first and second chutes 150 and 152, resulting in airstream redirection into at least second and third directions 134 and 136, as seen in the airflow diagrams of FIG. 7. In should be appreciated that, in other embodiments, the inner sidewalls may be joined along their upper ends, either entirely, substantially, or at a portion of the upper ends.

A discharged airstream from the radiator 14 travels downwardly through the first and second chutes 150 and 152 to the respective left and right sides of the vehicle 10. The airstream that exits chutes 150 and 152 is directed rearward and substantially parallel to the ground. In this embodiment, as the heated airstream exits the first and second chutes 150 and 150, the airstream 16 is directed away from the oil pan of the engine 12. Directing the heated airstream away from the oil pan helps to maintain cooler oil temperatures. As described above with reference to the previous embodiment, the outer side walls 144a and 144b of the chutes 150 and 152 may also flare outwardly away from the splitting device 126 to redirect the discharged airstream 16 substantially lateral or parallel to the ground and substantially outwardly (i.e., to the left and right sides of the vehicle 10).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. While illustrative embodiments have been illustrated and described, it will be appreciated that various changes can be made therein without departing from the spirit and scope of the disclosure.

1. In a vehicle of the type having an engine and a radiator, an airflow diverter is attachable in fluid receiving communication with the radiator, the airflow diverter comprising:
a formed foil having a downwardly and rearwardly extending arcuate portion, the formed foil, when placed in an airstream, capable of redirecting the airstream from a first direction to at least a second direction.

2. The airflow diverter of claim 1, wherein the at least first direction is substantially downward relative to the vehicle.

3. The airflow diverter of claim 1, wherein the at least second direction is substantially rearward relative to the vehicle.

4. The airflow diverter of claim 1, wherein the at least second direction is substantially lateral to the first direction.

5. The airflow diverter of claim 1, wherein the arcuate portion includes at least a first radius of curvature and at least a second radius of curvature, such that the first radius of curvature is less than the second radius of curvature.

6. The airflow diverter of claim 1, wherein the formed foil further includes at least first and second sidewalls.

7. The airflow diverter of claim 6, wherein first and second sidewalls are substantially perpendicular to the arcuate portion.

8. The airflow diverter of claim 6, wherein first and second sidewalls flare outwardly relative to the arcuate portion.

9. The airflow diverter of claim 1, wherein the formed foil is configured to form a partial vacuum pocket at a first pressure when placed in an airstream at a second pressure.

10. The airflow diverter of claim 1, wherein the formed foil includes at least first and second chutes, wherein the first and second chutes are divided by a splitting device, and wherein the airstream is redirected to at least second and third directions.

11. In a vehicle of the type having an engine and a radiator, an airflow diverter is attachable in fluid receiving communication with the radiator, the airflow diverter comprising:
a formed foil having first and second chutes, each chute having a downwardly and rearwardly extending arcuate portion, the first chute, when placed in an airstream, capable of redirecting the airstream from a first direction to at least a second direction, and the second chute, when placed in an airstream, capable of redirecting the airstream from a first direction to at least a third direction.
